(19) United States
(12) Patent Application Publication
(10) Pub. No.: US 2011/0228405 A1
(43) Pub. Date: Sep. 22, 2011

(54) OPTICAL LENS AND METHOD FOR PRODUCING AN OPTICAL LENS

(75) Inventors: Peter Frey, Heidenheim (DE); Peter Helbig, Sontheim/Brenz (DE); Philipp Helbig, Heidenheim (DE)

(73) Assignee: OSRAM GESELLSCHAFT MIT BESCHRAENKTER HAFTUNG, Muenchen (DE)

(21) Appl. No.: 13/129,131

(22) PCT Filed: Nov. 4, 2009
(86) PCT No.: PCT/EP09/64642

§ 371 Date: May 13, 2011

(30) Foreign Application Priority Data
Nov. 14, 2008 (DE) 10 2008 057 356.6

(51) Int. Cl. G02B 3/00; B29D 11/00

(52) U.S. Cl. 359/642; 264/1.7

(57) ABSTRACT

In various embodiments, an optical lens is provided, which is shaped like a hood and has a light-transmissive front face as well as a sidewall adjacent thereto, wherein the sidewall has at least one ridge-like section having an increased wall thickness and running in the direction of the front face.

The invention relates to an optical lens according to the preamble of claim 1 and to a manufacturing method for producing an optical lens of said type.

### I. PRIOR ART

The German utility model patent application DE 298 13 531 U1 discloses an optical lens for headlamps. The optical lens has a central lens part and at least one lens ring adjoining the central lens part via a circumferential face.

### II. SUMMARY OF THE INVENTION

The object of the invention is to provide an improved optical lens for headlamps and a manufacturing method for producing a lens of said type.

This object is achieved according to the invention by means of the features of claims 1 and 5 respectively. Particularly advantageous embodiments of the invention are described in the dependent claims.

The optical lens according to the invention is characterized by its hood-like shape and also in that it has a light-transmissive front face as well as a sidewall adjacent thereto, the sidewall having at least one ridge-like section having an increased wall thickness and running in the direction of the front face.

By virtue of the hood-like shape of the optical lens the light source and any other optical elements of a lighting unit, such as a reflector for example, can be arranged under the optical lens, protected from external influences. Accordingly, no covering panel is required for protecting the light source. The hood-like shape also allows retaining means for the optical lens to be dispensed with, since the sidewall of the hood-like optical lens itself can be used for securing it. Furthermore, by means of the hood-like shape of the optical lens it is possible to achieve a gas-tight arrangement of the light source and any other optical elements under the hood-like optical lens by sealing off the interface between the optical lens and a housing of a lighting unit which includes the optical lens as a component. Owing to the fact that the sidewall of the optical lens according to the invention has a ridge-like section having an increased wall thickness it is ensured that the inventive optical lens can be manufactured by means of an injection molding method and that no cavities will form in the region of the front face of the optical lens during said manufacturing method. During the injection molding process sufficient additional material can be supplied via the at least one ridge-like wall section having an increased wall thickness in order to prevent the formation of cavities in the front face as the material cools down.

Advantageously, the at least one ridge-like section having an increased wall thickness extends as far as the edge of the sidewall disposed opposite the front face. This enables the gate system for injection molding the optical lens according to the invention to be placed against the edge of the lens such that the optically effective area of the lens and in particular the light-refracting surfaces on the front face of the lens are not adversely affected by residues from the injection molding process.

The manufacturing method according to the invention for producing a hood-shaped optical lens which has a front face and a sidewall adjacent thereto is characterized in that the optical lens is produced by means of injection molding, there being provided in the sidewall of the optical lens a feed channel whose cross-section is greater than the thickness of the sidewall and via which material for the front face of the optical lens is supplied.

During the injection molding process, additional material for the front face of the optical lens is continuously supplied via said feed channel. In particular, additional material for the front face of the optical lens can continue to be supplied via said feed channel even when the material in the thin-walled sections of the sidewall has already cooled down and solidified. On account of its comparatively large cross-section the material in the feed channel sets later than in the other wall sections and it is possible to add more material to the front face having the optically effective surfaces right to the end, that is to say until the material in the front face solidifies. In this way it is ensured that no cavities form in the front face as the material sets.

The invention therefore enables the comparatively low-cost injection molding method to be used. This removes the need for more complex and expensive methods such as injection embossing for example.

In the manufacturing method according to the invention the at least one feed channel preferably extends as far as the edge of the sidewall disposed opposite the front face and the gate is preferably arranged at the edge of the sidewall in the region of the feed channel. In this way it is ensured that no residues from the injection molding method can compromise the quality of the focusing properties of the lens in the optically effective area of the lens.

The manufacturing method according to the invention is in particular well-suited for manufacturing hood-like optical lenses which, owing to at least one convexly or concavely curved light-refracting surface on their front face, have a front face having a comparatively great wall thickness, the material of which sets during injection molding only after a long period of time in comparison with the sidewall material.

For reasons of cost and in the interests of easy manufacture, the optical lens according to the invention is preferably made of plastic, in particular of polycarbonate or polymethylmethacrylate.

### III. DESCRIPTION OF THE PREFERRED EXEMPLARY EMBODIMENT

The invention is explained in more detail below with reference to a preferred exemplary embodiment and the drawing, in which:

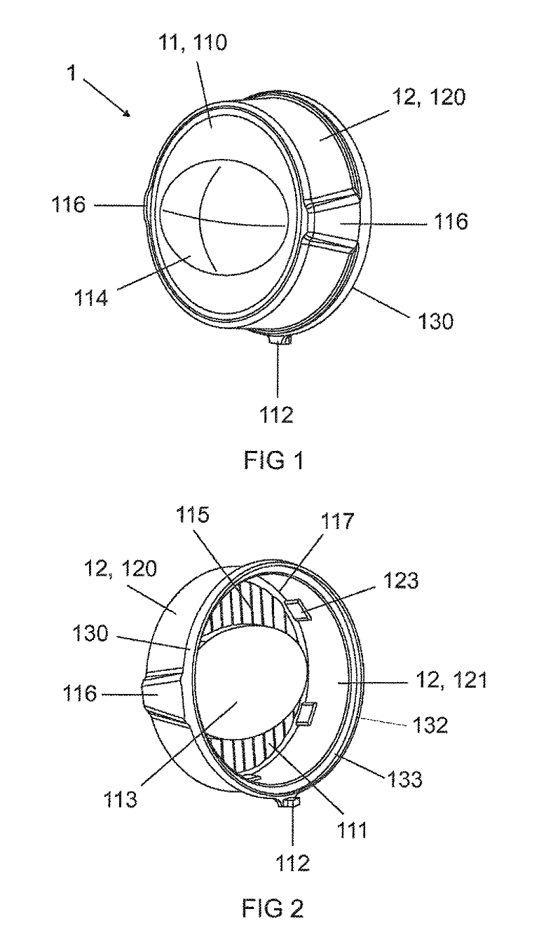

FIG. 1 shows a side view onto the outside of the optical lens embodied in a hood shape according to the preferred exemplary embodiment of the invention,

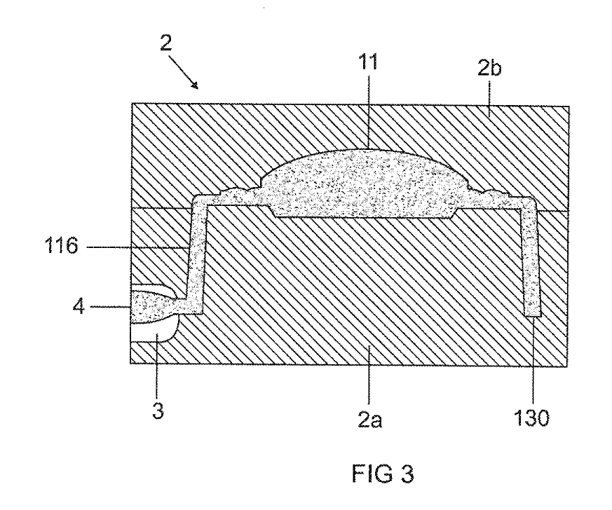

FIG. 2 shows a side view onto the inside of the optical lens depicted in FIG. 1, and

FIG. 3 shows a cross-section through the injection mold used for producing the optical lens depicted in FIGS. 1 and 2 in a schematic representation.

FIGS. 1 and 2 show different views of the optical lens according to the preferred exemplary embodiment of the invention. The optical lens 1 is shaped like a hood and embodied as a single piece. It consists of light-transmissive polycarbonate. The optical lens 1 has a front face 11 and a ring-shaped sidewall 12. The front face 11 and the sidewall 12 adjacent thereto form the hood shape of the optical lens 1. FIG. 1 shows the outside or front side of the optical lens 1 according to the invention and hence also the outside 110 of its front face 11 and the outside 120 of its sidewall 12. FIG. 2 shows the inside of the hood-like optical lens 1. On its inside 111 the front face 11 has a first light-refracting surface 113 which is arranged centrally on the front face 11, is delimited by an elliptical edge and is embodied as planar. Outside the first light-refracting surface 113, the inside 111 of the front face 11 is provided with ribs 115 running parallel to one another and imparting light-scattering properties to the front face 11 in this area. On its outside 110 the front face 11 has a second light-refracting surface 114 which is arranged centrally on the front face 11, is delimited by an elliptical edge and is convexly curved. The first 113 and second light-refracting surfaces 114 correspond to each other and form a non-rotationally-symmetrical, aspheric lens whose optical axis runs vertically with respect to the planar first light-refracting surface 113 and coincides with the ring axis of the ring-shaped sidewall 12. Outside the second light-refracting surface 114, the outside 110 of the front face 11 is embodied as planar. Owing to the ribs 115 arranged on its inside 111, the front face 11 possesses light-scattering properties outside the second light-refracting surface 114. The front face 11 has an increased wall thickness in the region of the aspheric lens formed by the two light-refracting surfaces 113, 114. On its inside 111, the front face 11 also has a circular-ring-shaped, flat support surface 117 which forms the outer edge of the front face 11 and can serve as a support surface for a reflector of a lighting unit which includes the optical lens as a component. The sidewall 12 is embodied as slightly conical. In other words, the inner diameter and outer diameter of the sidewall 12 increase slightly with increasing distance from the front face 11. On the inside 121 of the sidewall 12, in immediate proximity to the front face 11, five projections 123 projecting into the interior of the hood-like optical lens 1 are arranged equidistantly along its circumference. Additionally arranged on the inside is a reference lug 125 projecting into the interior of the hood-like optical lens 1. The reference lug 125 has a different shape from the projections 123 and can therefore serve for establishing the angular position of a reflector of a lighting unit. Said projections 123 form stop surfaces for the reflector of the lighting unit and together with the support surface 117 and the reference lug 125 serve to ensure the correctly positioned installation, alignment and arrangement of the reflector in relation to the optical lens 1.

At its end disposed opposite the front face 11 the hood-like optical lens 1 or its sidewall 12 has a circular-ring-shaped, graduated edge 130. The inner diameter of the sidewall 12 is extended in a step-like manner in the region of the graduated edge 130. The edge 130 therefore embodies a circularly cylindrical lateral surface 132 on the inside of the sidewall 12 and a ring-shaped support surface 133 arranged in parallel with the front face 11. The lateral surface 132 can therefore define a reference diameter for the three-dimensional orientation and alignment of a light-emitting diode arrangement 3 of a lighting unit in relation to the hood-like optical lens 1. The support surface 132 adjoins the light-emitting diode arrangement and defines a reference plane for the relative positioning of optical lens 1 and light-emitting diode arrangement. In addition, a further reference lug 112 is integrally molded on the edge 130 and can be used for establishing the relative angular position between the optical lens 1 and a light-emitting diode arrangement.

On its sidewall 12 the optical lens 1 has two ridges 116 which are disposed opposite each other and in each case extend from the edge 130 up to the front face 11. The sidewall 12 has an increased wall thickness in the region of the ridges 116. Only one of said ridges 116 is required for performing the injection molding method according to the invention.

FIG. 3 schematically shows a cross-section through the injection mold 2 for producing the optical lens 1. The injection mold 2 consists of two halves 2a, 2b which can be joined together. The two halves 2a, 2b of the injection mold form a cavity which possesses the shape of the optical lens 1 according to the invention. The gate system 3 for filling the cavity of the injection mold 2 is arranged on the edge 130 of the lens mold 2 disposed opposite the front face 11. The heated, liquid plastic material 4 is channeled from the gate 3 via the sidewall 112 and in particular via the ridge-like section 116 having an increased wall thickness to the front face 11 of the lens or, as the case may be, the lens mold. Said ridge-like section 116 of the sidewall 12 or the corresponding section of the injection mold still forms a material feed channel 1 for the front face 11 of the lens or the corresponding cavity of the lens mold even when the material in the other thin-walled sections of the lens or lens mold and in the areas close to the wall of the injection mold 2 has already solidified due to premature cooling.

1. An optical lens,
being shaped like a hood and comprising a light-transmissive front face as well as a sidewall adjacent thereto,
wherein the sidewall comprises at least one ridge-like section having an increased wall thickness and running in the direction of the front face.

2. The optical lens as claimed in claim 1,
wherein the at least one ridge-like section extends from the front face up to the edge of the sidewall disposed opposite the front face.

3. The optical lens as claimed in claim 1,
wherein the front face has at least one convexly or concavely curved light-refracting surface.

4. The optical lens as claimed in claim 1,
wherein the optical lens is made of plastic.

5. A method for producing an optical lens which is shaped like a hood and has a front face and a sidewall adjacent thereto by means of injection molding, the method comprising:
providing a feed channel in the sidewall of the optical lens via which material for the front face of the optical lens is supplied and the cross-section of which is greater than the wall thickness of the sidewall.

6. The method as claimed in claim 5,
wherein the feed channel extends up to the edge of the sidewall disposed opposite the front face and the gate is arranged at the edge of the sidewall in the region of the feed channel.
